(19) United States
(12) Patent Application Publication
(10) Pub. No.: US 2007/0202409 A1
(43) Pub. Date: Aug. 30, 2007

(54) LITHIUM/IRON DISULFIDE PRIMARY CELL

(75) Inventors: Naoko Yamakawa, Tokyo (JP); Ryosuke Takagi, Tokyo (JP); Hiroshi Imoto, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/678,382

(22) Filed: Feb. 23, 2007

(30) Foreign Application Priority Data
Feb. 24, 2006 (JP) 2006-048280

(51) Int. Cl. H01M 4/58; H01M 6/16

(52) U.S. Cl. 429/231.95; 429/221; 429/330; 429/331; 429/333; 429/337; 429/338; 429/341

(57) ABSTRACT

There is provided a lithium/iron disulfide primary cell which includes a positive electrode using iron disulfide as a positive active material, a negative electrode using lithium as a negative active material, and an organic electrolytic solution, in which the organic electrolytic solution contains a transition metal cation.

### CROSS REFERENCES TO RELATED APPLICATIONS

The present application claims priority to Japanese Patent Application JP 2006-048280 filed in the Japanese Patent Office on Feb. 24, 2006, the entire contents of which is being incorporated herein by reference.

### BACKGROUND

The present disclosure relates to a lithium/iron disulfide primary cell having a positive electrode using iron disulfide as a positive active material, a negative electrode using lithium as a negative active material, and an electrolytic solution using an organic solvent.

Lithium/iron disulfide primary cells are composed of positive and negative electrode materials showing extremely large theoretical capacities, such as approximately 894 mAh/g shown by iron disulfide as a positive active material, and approximately 3,863 mAh/g shown by lithium as a negative active material, and is known as an excellent cell also from viewpoints of large capacity, light weight, load characteristics, and low-temperature characteristics.

In addition, the lithium/iron disulfide primary cells have a large value of practical use, because it shows an initial open-circuit voltage (OCV) of 1.7 V to 1.8 V and a mean discharge voltage of 1.3 V to 1.6 V or around, which is compatible with other 1.5-V-class primary cells such as manganese cell, alkali manganese cell, silver oxide cell, air cell and nickel/zinc cell, all of which using aqueous solution as an electrolytic solution.

The cell system, however, suffers from a problem in that the open-circuit voltage thereof elevates up to a level higher than the practical voltage, immediately after being manufactured. It is, therefore, a general technique that the open-circuit voltage is lowered by preliminary discharge after the manufacturing down to as low as the practical voltage, but the cell system has a characteristic in that the open-circuit voltage elevates again during storage over a long period, even to as high as exceeding 2 V in some cases.

In a case where the lithium/iron disulfide primary cell with an elevated open-circuit voltage is used for a device, the device will be disabled because protection circuits thereof will be activated so as to interrupt power supply. In other words, this situation raises a problem of ruining the compatibility with other 1.5-V-class primary cells.

It is conceivable that elevation in the open-circuit voltage is ascribable to influence of oxygen adsorbed to an electro-conductive material. For the purpose of suppressing the influence, Japanese Laid-Open Patent Application Publication No. SHO 59-181464, for example, describes a method of removing any active species in the electro-conductive material, through reduction with the aid of an isoxazole derivative added to the electrolytic solution and a reducing agent added to the positive electrode.

It is conceivable that elevation in the open-circuit voltage is also ascribable to invasion of external water, and consequent reaction with cell constituents. For the purpose of suppressing the influence, Japanese Laid-Open Patent Application Publication No. HEI 8-153521, for example, describes a method of allowing the invaded water to preferentially react with phenol or a hydroquinone derivative added to the electrolytic solution.

The methods of using the additives, as described in Japanese Laid-Open Patent Application Publication No. SHO 59-181464 and Japanese Laid-Open Patent Application Publication No. HEI 8-153521, are successful in suppressing elevation of the open-circuit voltage, but anticipated for degradation in the discharge characteristics.

### SUMMARY

The present embodiments provide a lithium/iron disulfide primary cell less causative of degradation in the discharge characteristics, and capable of suppressing elevation in the open-circuit voltage during storage.

In order to solve the above-described problems, an embodiment provides a lithium/iron disulfide primary cell including a positive electrode using iron disulfide as a positive active material; a negative electrode using lithium as a negative active material; and an organic electrolytic solution, in which the organic electrolytic solution contains a transition metal cation.

According to the embodiment, because the organic electrolytic solution contains a transition metal cation, the discharge characteristics is less lowered, and elevation of the open-circuit voltage during storage over a long period can be suppressed. Cu ion and other transition metal cations including Sn ion, Zn ion, Ni ion and Ag ion are ready to form compounds with S, and are supposed to form a stable inorganic coating as being incorporated into the positive electrode. It is also conceivable that formation of the sulfur compounds allows the positive electrode to stand in a different potential environment, and thereby succeeds in suppressing various reactions causative of elevation in the open-circuit voltage during storage.

Additional features and advantages are described herein, and will be apparent from, the following Detailed Description and the figures.

### BRIEF DESCRIPTION OF THE FIGURES

FIG. 1 is a sectional side elevation of a lithium/iron disulfide primary cell according to one embodiment.

### DETAILED DESCRIPTION

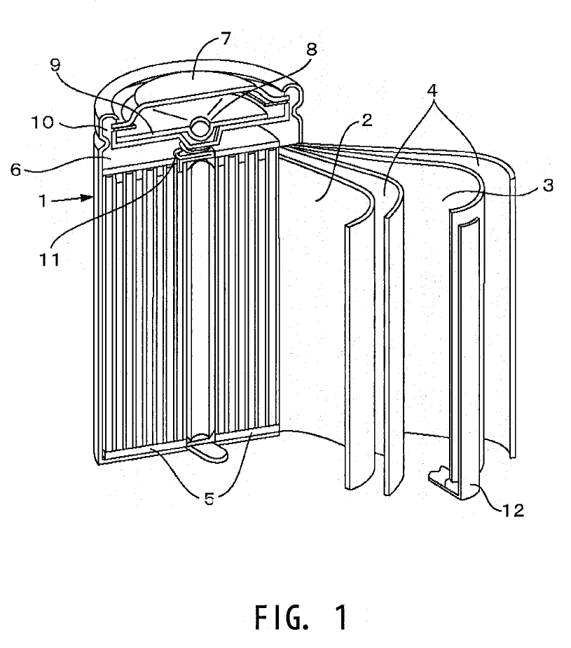

FIG. 1 shows a lithium/iron disulfide primary cell according to one embodiment. The cell shown in FIG. 1 is of so-called cylindrical type, and has a spiral electrode assembly enclosed in a hollow near-cylindrical cell can 1. The spiral electrode assembly is composed of a band-like positive electrode 2 having a positive active material, and a band-like negative electrode 3 having a negative active material rolled up multiple number of turns, while holding an ion-permeative separator 4 in between.

The cell can 1 is composed of, for example, nickel-plated iron, closed at one end, and opened at the other end. Inside the cell can 1, a pair of insulating plate 5 and insulating plate 6 are disposed normal to the peripheral wall, so as to hold the spiral electrode assembly in between.

To the open end of the cell can 1, there are attached a cell lid 7, a safety valve 8 and a heat-sensitive resistor (positive temperature coefficient (PTC) element) 9 provided to the inner side of the cell lid 7, as being caulked while placing a sealing gasket 10 in between, and thereby the inner space of the cell can 1 is tightly closed.

The cell lid 7 is composed of the same material with the cell can 1, for example. The safety valve 8 is electrically connected through the heat-sensitive resistor 9 to the cell lid 7, and is provided with so-called current interruption mechanism capable of disconnecting the cell lid 7 from the spiral electrode assembly, if the internal pressure should exceed a predetermined level, due to internal short-circuiting, heating from the external, or the like.

The heat-sensitive resistor 9 increases the resistivity thereof as temperature rises so as to limit current which flows therethrough, to thereby prevent abnormal heat generation due to large current, and is composed of a barium-titanate-base semiconductor ceramic, for example. The sealing gasket 10 is composed of, for example, an insulating material, having asphalt coated on the surface thereof.

The positive electrode 2 of the spiral electrode assembly is connected with a positive electrode lead 11 composed of aluminum or the like, while the negative electrode 3 is connected with a negative electrode lead 12 composed of nickel or the like. The positive electrode lead 11 is electrically connected to the cell lid 7, as being welded to the safety valve 8. The negative electrode lead 12 is welded, and thereby electrically connected, to the cell can 1.

The separator 4 between the positive electrode 2 and the negative electrode 3 is impregnated, for example, with a non-aqueous electrolytic solution as the non-aqueous electrolyte. The separator 4 has functions of preventing physical contact of the positive electrode 2 with the negative electrode 3, as being disposed between the positive electrode 2 and the negative electrode 3. Moreover, the separator 4 can absorb the non-aqueous electrolytic solution so as to retain it into the pores, allowing lithium ion to pass therethrough during discharge.

[Positive Electrode 2]

The positive electrode 2 is composed of a band-like positive electrode current collector, and positive electrode mix layers formed on both surfaces of the positive electrode current collector. The positive electrode current collector is a metal foil composed of, for example, an aluminum (Al) foil, nickel (Ni) foil, stainless steel (SUS) foil or the like.

The positive electrode mix layer is composed of, for example, iron disulfide (FeS₂) being the positive active material, an electro-conductive material, and a binder. Iron disulfide, which is a positive active material, used herein is typically a crushed product of naturally-occurring (pyrite), whereas it is also allowable to use iron disulfide obtained by chemical synthesis such as, for example, sintering of iron (II) chloride (FeCl₂) in hydrogen sulfide (H₂S).

The electro-conductive material is not specifically limited so far as it can impart electro-conductivity to the positive active material as being mixed therewith to an appropriate amount, examples of which include carbon powders such as graphite and carbon black. The binder may be any of publicly-known ones, and examples of which include fluorocarbon resins such as polyvinyl fluoride (PVF), polyvinylidene fluoride (PVDF) and polytetrafluoroethylene.

[Negative Electrode 3]

The negative electrode 3 is composed of a band-like metal foil. Examples of material composing the metal foil, which is also a negative active material, include lithium metal, or lithium alloy obtained by adding an alloying element, such as aluminum, to lithium.

[Electrolytic Solution]

The electrolytic solution used herein is the one obtained by dissolving a lithium salt as an electrolyte into an organic solvent. The electrolytic solution contains only a transition metal cation. By virtue of this configuration, the lithium/iron disulfide primary cell is successfully prevented from being elevated in the open-circuit voltage over a long period of storage.

Examples of applicable transition metal cation include Cu ion, and also Sn ion, Zn ion, Ni ion and Ag ion. The transition metal cation can be included in the electrolytic solution, for example, by addition to the electrolytic solution, in a form of a salt composed of a transition metal cation and a pair-forming anion species. Examples of the salt include triflate salt, perchlorate salt and halogen salt. Among these salts, triflate salt is more preferable, because the triflate anion does not so heavily affect the cell characteristics. The triflate salt is generally expressed by formula I below:
Meⁿ⁺(CF₃SO₃)ₙ (Formula I)

(where, Meⁿ⁺ expresses a transition metal cation, and n represents the number of valence of the transition metal cation).

Contents of the transition metal cation in the electrolytic solution is preferably adjusted within the range from 0.01 mol/kg to 1.0 mol/kg, in view of sufficiently obtaining the effect of suppressing elevation of the open-circuit voltage, and of causing only a less degree of degradation in the discharge characteristics.

Examples of the organic solvent include propylene carbonate, ethylene carbonate, 1,2-dimethoxy ethane, γ-butyrolactone, tetrahydrofuran, 2-methyl tetrahydrofuran, 1,3-dioxolane, sulfolane, acetonitrile, dimethyl carbonate and dipropyl carbonate, and any one of them or two or more of them can be used independently or in a form of mixed solvent.

Examples of the electrolyte applicable herein include, LiClO₄, LiPF₆, LiBF₄, LiCF₃SO₃, LiC₄F₉SO₃, LiAs₆, LiI, LiBr, Li(CF₃SO₂)₂N, Li(C₂F₅SO₂)(CF₃SO₂)N and Li(C2F₅SO₂)₂N.

[Separator]

As the separator 4, polyolefin-base, micro-porous film composed of polypropylene, polyethylene or the like can be used.

Paragraphs below will describe a method of fabricating the lithium/iron disulfide primary cell according to the embodiment.

First, a positive electrode mix is prepared by mixing, for example, a positive active material, a binder, and an electro-conductive material, and the obtained positive mix is dispersed into a solvent such as N-methyl-2-pyrrolidone (NMP), to thereby prepare a paste-like positive electrode mix slurry. The positive electrode mix slurry is coated and dried on the positive electrode current collector, and the product is then subjected to compression molding typically using a roller press machine, to thereby form a positive electrode mix layer. The positive electrode 2 is thus fabricated.

Next, the band-like positive electrode 2 obtained as described above, the band-like negative electrode 3, and the band-like separator 4 are stacked in the order of the positive electrode 2, the separator 4, the negative electrode 3, and the separator 4, for example, and the stack is then rolled up multiple number of times in the longitudinal direction thereof, to thereby fabricate a spiral electrode assembly.

Next, the spiral electrode assembly is then housed in the cell can 1 having the insulating plate 5 preliminarily inserted to the bottom, and having a nickel layer preliminarily plated on the inner wall thereof. The insulating plate 6 is then disposed on the top of the spiral electrode assembly. Thereafter, one end of the negative electrode lead 12 composed of, for example, nickel is attached to the negative electrode 3 so as to enable current collection from the negative electrode 3, and the other end is welded to the cell can 1.

By these processes, the cell can 1 is made so as to ensure electro-conduction with the negative electrode 3, and serves as an external negative electrode. On the other hand, one end of the positive electrode lead 11 made of, for example, aluminum is attached to the positive electrode 2 so as to enable current collection from the positive electrode 2, and the other end is electrically connected through the safety valve 8 to the cell lid 7. By these processes, the cell lid 7 is made so as to ensure electro-conduction with the positive electrode 2, and serves as an external positive electrode.

An electrolytic solution added with a transition metal cation is injected into the cell can 1, and the cell can 1 is caulked so as to surround the sealing gasket 10 coated with asphalt. In this way, a cylindrical lithium/iron disulfide primary cell is fabricated.

### EXAMPLES

Paragraphs below describe Examples of the present embodiments.

TABLE 1

| | | | Amount | | Discharge |
|---|---|---|---|---|---|
| | | | of | | time |
| | Salt | Meⁿ⁺(CF₃SO₃)ₙ | addition | OCV (V) | ratio |
| Example 1 | LiI | Cu | 0.005 | 1.961 | 1.01 |
| Example 2 | LiI | Cu | 0.01 | 1.921 | 1.02 |
| Example 3 | LiI | Cu | 0.1 | 1.873 | 1.03 |
| Example 4 | LiI | Cu | 0.25 | 1.862 | 1.00 |
| Example 5 | LiI | Cu | 0.5 | 1.850 | 0.981 |
| Example 6 | LiI | Cu | 0.75 | 1.845 | 0.952 |
| Example 7 | LiI | Cu | 1 | 1.840 | 0.931 |
| Example 8 | LiI | Cu | 1.25 | 1.839 | 0.901 |
| Example 9 | LiI | Cu | 1.5 | 1.837 | 0.852 |
| Example 10 | LiI | Sn | 0.005 | 1.972 | 1.02 |
| Example 11 | LiI | Sn | 0.01 | 1.935 | 1.03 |
| Example 12 | LiI | Sn | 0.1 | 1.895 | 1.05 |
| Example 13 | LiI | Sn | 0.25 | 1.883 | 1.00 |
| Example 14 | LiI | Sn | 0.5 | 1.871 | 0.991 |
| Example 15 | LiI | Sn | 0.75 | 1.865 | 0.963 |
| Example 16 | LiI | Sn | 1 | 1.861 | 0.921 |
| Example 17 | LiI | Sn | 1.25 | 1.860 | 0.872 |
| Example 18 | LiI | Sn | 1.5 | 1.858 | 0.831 |
| Example 19 | LiI | Zn | 0.005 | 1.970 | 0.991 |
| Example 20 | LiI | Zn | 0.01 | 1.943 | 0.982 |
| Example 21 | LiI | Zn | 0.1 | 1.921 | 0.973 |
| Example 22 | LiI | Zn | 0.25 | 1.901 | 0.955 |
| Example 23 | LiI | Zn | 0.5 | 1.885 | 0.935 |
| Example 24 | LiI | Zn | 0.75 | 1.882 | 0.902 |
| Example 25 | LiI | Zn | 1 | 1.873 | 0.875 |
| Example 26 | LiI | Zn | 1.25 | 1.871 | 0.853 |
| Example 27 | LiI | Zn | 1.5 | 1.872 | 0.835 |
| Example 28 | LiI | Ni | 0.005 | 1.971 | 0.991 |
| Example 29 | LiI | Ni | 0.01 | 1.953 | 0.985 |
| Example 30 | LiI | Ni | 0.1 | 1.932 | 0.952 |
| Example 31 | LiI | Ni | 0.25 | 1.915 | 0.931 |
| Example 32 | LiI | Ni | 0.5 | 1.901 | 0.915 |
| Example 33 | LiI | Ni | 0.75 | 1.892 | 0.905 |
| Example 34 | LiI | Ni | 1 | 1.885 | 0.862 |
| Example 35 | LiI | Ni | 1.25 | 1.883 | 0.841 |
| Example 36 | LiI | Ni | 1.5 | 1.882 | 0.802 |
| Example 37 | LiI | Ag | 0.005 | 1.971 | 1.10 |
| Example 38 | LiI | Ag | 0.01 | 1.932 | 1.12 |
| Example 39 | LiI | Ag | 0.1 | 1.881 | 1.12 |
| Example 40 | LiI | Ag | 0.25 | 1.870 | 1.00 |
| Example 41 | LiI | Ag | 0.5 | 1.865 | 0.982 |
| Example 42 | LiI | Ag | 0.75 | 1.861 | 0.971 |
| Example 43 | LiI | Ag | 1 | 1.853 | 0.844 |
| Example 44 | LiI | Ag | 1.25 | 1.854 | 0.932 |
| Example 45 | LiI | Ag | 1.5 | 1.852 | 0.915 |
| Comparative | LiI | — | — | 1.980 | 1.000 |
| Example 1 | | | | | |

Table 1 relates to Example 1 to Example 45, and Comparative Example 1. Paragraphs below will describe Example 1 to Example 45, and Comparative Example 1, referring to Table 1.

### Example 1

First, 95% by weight of iron disulfide as the positive active material, 1.0% by weight of carbon powder as the electro-conductive material, and 4% by weight of a polyvinylidene fluoride as the binder were mixed, and then thoroughly dispersed in N-methyl-2-pyrrolidone as the solvent, to thereby prepare a positive electrode mix slurry.

Next, the positive electrode mix slurry was coated on both surfaces of the positive electrode current collector, and allowed to dry at 120° C. for 2 hours so as to vaporize N-methyl-2-pyrrolidone, and the product was subjected to compression molding under a constant pressure, to thereby fabricate a band-like positive electrode 2. The positive electrode current collector used herein was a band-like aluminum foil of 20 μm thick.

Next, thus-fabricated, band-like positive electrode 2 and the metal lithium negative electrode 3 of 150 μm thick were stacked in the order of the positive electrode 2, the separator 4, the negative electrode 3 and the separator 4, and then rolled up multiple number of turns, to thereby fabricate a spiral electrode assembly having an external diameter of 9 mm.

The spiral electrode assembly obtained as described in the above was housed into an iron-made, nickel-plated cell can 1. The insulating plate 5 and the insulating plate 6 were then placed on both of the upper and lower surfaces of the spiral electrode assembly, an aluminum-made positive electrode lead 11 was drawn out from the positive electrode current collector and welded to the cell lid 7, and a nickel-made negative electrode lead 12 was drawn out from the negative electrode current collector and welded to the cell can 1.

Next, 1.0 mol/kg of lithium iodide (LiI) and 0.005 mol/kg of transition metal cation (Cu ion) in a form of triflate salt were added and dissolved into a mixed solvent based on a volumetric ratio of 2:1 of 1,3-dioxolane (DOL) and 1,2-dimethoxy ethane (DME), and thus-prepared electrolytic solution was injected into the cell can 1. The amount of addition of the metal triflate salt is determined by ICP (Inductively Coupled Plasma), and expressed by concentration (mol/kg) with respect to the total solvent in the electrolytic solution.

Next, the cell can 1 was caulked with the insulating sealing gasket 10 having the asphalt coating on the surface thereof in between, so as to fix the safety valve 8 having the current interruption mechanism, the heat-sensitive resistor 9 and the cell lid 7, to thereby keep air tightness of the inner space of the cell. In this way, a cylindrical lithium/iron disulfide primary cell of approximately 10 mm in diameter, and approximately 44 mm in height was fabricated.

### Example 2 to Example 9

Lithium/iron disulfide primary cells of Example 2 to Example 9 were fabricated similarly to Example 1, except that Cu ion in a form of triflate salt was added to as much as the amounts listed in Table 1.

### Example 10 to Example 18

Lithium/iron disulfide primary cells of Example 10 to Example 18 were fabricated similarly to Example 1, except that Sn ion in a form of triflate salt was added to as much as the amounts listed in Table 1.

### Example 19 to Example 27

Lithium/iron disulfide primary cells of Example 19 to Example 27 were fabricated similarly to Example 1, except that Zn ion in a form of triflate salt was added to as much as the amounts listed in Table 1.

### Example 28 to Example 36

Lithium/iron disulfide primary cells of Example 28 to Example 36 were fabricated similarly to Example 1, except that Ni ion in a form of triflate salt was added to as much as the amounts listed in Table 1.

### Example 37 to Example 45

Lithium/iron disulfide primary cells of Example 37 to Example 45 were fabricated similarly to Example 1, except that Ag ion in a form of triflate salt was added to as much as the amounts listed in Table 1.

### Comparative Example 1

A lithium/iron disulfide primary cell of Comparative Example 1 was fabricated similarly to Example 1, except that the transition metal cation was not added.

Evaluation

Thus-fabricated lithium/iron disulfide primary cells of Example 1 to Example 45, and of Comparative Example 1 were allowed to discharge by preliminary discharge to as much as 10% or around of the cell capacity, kept at room temperature (20° C.) for 1,000 hours, and the open-circuit voltage of thus-stored cells was measured. Results were shown in Table 1.

It is obvious from Table 1 that, by using the transition metal cations listed in Table 1, elevation of the open-circuit voltage could be largely suppressed. The effect, however, saturated at 1.0 mol/kg.

Table 1 also shows discharge time ratios of the lithium/iron disulfide primary cells of Example 1 to Example 45 under 10⁻⁹ discharge down to a discharge termination voltage of 0.9 V, calculated assuming the value of Comparative Example 1 as 1.00. As is known from Table 1, the amount of addition exceeding 1.0 mol/kg resulted in considerable lowering in the discharge characteristics. The amount of addition is, therefore, preferably adjusted to 1 mol/kg or less.

For the purpose of examining further addition (0.5 mol/kg) of the transition metals to combinations of 1,3-dioxolane (DOL) and other solvents, which are propylene carbonate (PC) and ethylene carbonate (EC), with LiCF₃SO₃, LiClO₄, LiPF₆ and Li(CF₃SO₂)₂N, the present inventors fabricated also lithium/iron disulfide primary cells of Example 46 to Example 80, and Comparative Example 2 to Comparative Example 8. Table 2 below relates to Example 46 to Example 80, and Comparative Example 2 to Comparative Example 8. Paragraphs below describe Example 46 to Example 80, and Comparative Example 2 to Comparative Example 8, referring to Table 2.

TABLE 2

| | | | | Amount of | |
|---|---|---|---|---|---|
| | | | | addition | |
| | Salt | Solvent X/DME | Meⁿ⁺(CF₃SO₃)ₙ | (mol/kg) | OCV (V) |
| Example 46 | LiCF₃SO₃ | DOL | Cu | 0.50 | 1.880 |
| Example 47 | LiCF₃SO₃ | DOL | Sn | 0.50 | 1.895 |
| Example 48 | LiCF₃SO₃ | DOL | Zn | 0.50 | 1.880 |
| Example 49 | LiCF₃SO₃ | DOL | Ni | 0.50 | 1.900 |
| Example 50 | LiCF₃SO₃ | DOL | Ag | 0.50 | 1.875 |
| Comparative | LiCF₃SO₃ | DOL | — | — | 2.000 |
| Example 2 | | | | | |
| Example 51 | LiClO₄ | DOL | Cu | 0.50 | 1.930 |
| Example 52 | LiClO₄ | DOL | Sn | 0.50 | 1.965 |
| Example 53 | LiClO₄ | DOL | Zn | 0.50 | 1.930 |
| Example 54 | LiClO₄ | DOL | Ni | 0.50 | 1.950 |
| Example 55 | LiClO₄ | DOL | Ag | 0.50 | 1.900 |
| Comparative | LiClO₄ | DOL | — | — | 2.200 |
| Example 3 | | | | | |
| Example 56 | LiPF₆ | DOL | Cu | 0.50 | 1.900 |
| Example 57 | LiPF₆ | DOL | Sn | 0.50 | 1.915 |
| Example 58 | LiPF₆ | DOL | Zn | 0.50 | 1.905 |
| Example 59 | LiPF₆ | DOL | Ni | 0.50 | 1.930 |
| Example 60 | LiPF₆ | DOL | Ag | 0.50 | 1.895 |
| Comparative | LiPF₆ | DOL | — | — | 2.000 |
| Example 4 | | | | | |
| Example 61 | Li(CF₃SO₂)₂N | DOL | Cu | 0.50 | 1.870 |
| Example 62 | Li(CF₃SO₂)₂N | DOL | Sn | 0.50 | 1.895 |
| Example 63 | Li(CF₃SO₂)₂N | DOL | Zn | 0.50 | 1.880 |
| Example 64 | Li(CF₃SO₂)₂N | DOL | Ni | 0.50 | 1.895 |
| Example 65 | Li(CF₃SO₂)₂N | DOL | Ag | 0.50 | 1.870 |
| Comparative | Li(CF₃SO₂)₂N | DOL | — | — | 1.990 |
| Example 5 | | | | | |
| Example 66 | LiCF₃SO₃ | PC | Cu | 0.50 | 1.915 |
| Example 67 | LiCF₃SO₃ | PC | Sn | 0.50 | 1.930 |
| Example 68 | LiCF₃SO₃ | PC | Zn | 0.50 | 1.925 |
| Example 69 | LiCF₃SO₃ | PC | Ni | 0.50 | 1.940 |
| Example 70 | LiCF₃SO₃ | PC | Ag | 0.50 | 1.910 |
| Comparative | LiCF₃SO₃ | PC | — | — | 2.100 |
| Example 6 | | | | | |
| Example 71 | LiClO₄ | PC | Cu | 0.50 | 1.930 |
| Example 72 | LiClO₄ | PC | Sn | 0.50 | 1.935 |
| Example 73 | LiClO₄ | PC | Zn | 0.50 | 1.925 |
| Example 74 | LiClO₄ | PC | Ni | 0.50 | 1.940 |
| Example 75 | LiClO₄ | PC | Ag | 0.50 | 1.910 |
| Comparative | LiClO₄ | PC | — | — | 2.200 |
| Example 7 | | | | | |
| Example 76 | LiPF₆ | EC | Cu | 0.50 | 1.920 |
| Example 77 | LiPF₆ | EC | Sn | 0.50 | 1.945 |
| Example 78 | LiPF₆ | EC | Zn | 0.50 | 1.930 |
| Example 79 | LiPF₆ | EC | Ni | 0.50 | 1.950 |
| Example 80 | LiPF₆ | EC | Ag | 0.50 | 1.925 |
| Comparative | LiPF₆ | EC | — | — | 2.300 |
| Example 8 | | | | | |

### Example 46 to Example 50

LiCF₃SO₃ was used in place of lithium iodide (LiI). The transition metal cations listed in Table 2 were added in a form of triflate salt to as much as the amounts of addition listed in Table 2. Except for this point, the lithium/iron disulfide primary cells of Example 46 to Example 50 were fabricated similarly to Example 1.

### Comparative Example 2

A lithium/iron disulfide primary cell of Comparative Example 2 was fabricated similarly to Example 46 to Example 50, except that the transition metal cation was not added.

### Example 51 to Example 55

LiClO₄ was used in place of lithium iodide (LiI). The transition metal cations listed in Table 2 were added in a form of triflate salt to as much as the amounts of addition listed in Table 2. Except for these points, the lithium/iron disulfide primary cells of Example 51 to Example 55 were fabricated similarly to Example 1.

### Comparative Example 3

A lithium/iron disulfide primary cell of Comparative Example 3 was fabricated similarly to Example 51 to Example 55, except that the transition metal cation was not added.

### Example 56 to Example 60

LiPF₆ was used in place of lithium iodide (LiI). The transition metal cations listed in Table 2 were added in a form of triflate salt, to as much as the amounts of addition listed in Table 2. Except for these points, the lithium/iron disulfide primary cells of Example 56 to Example 60 were fabricated similarly to Example 1.

### Comparative Example 4

A lithium/iron disulfide primary cell of Comparative Example 4 was fabricated similarly to Example 56 to Example 60, except that the transition metal cation was not added.

### Example 61 to Example 65

Li(CF₃SO₂)₂N was used in place of lithium iodide (LiI). The transition metal cations listed in Table 2 were added in a form of triflate salt, to as much as the amounts of addition listed in Table 2. Except for these points, the lithium/iron disulfide primary cells of Example 61 to Example 65 were fabricated similarly to Example 1.

### Comparative Example 5

A lithium/iron disulfide primary cell of Comparative Example 5 was fabricated similarly to Example 61 to Example 65, except that the transition metal cation was not added.

### Example 66 to Example 70

LiCF₃SO₃ was used in place of lithium iodide (LiI). Propylene carbonate (PC) was used in place of 1,3-dioxolane (DOL). The transition metal cations listed in Table 2 were added in a form of triflate salt, to as much as the amounts of addition listed in Table 2. Except for these points, the lithium/iron disulfide primary cells of Example 66 to Example 70 were fabricated similarly to Example 1.

### Comparative Example 6

A lithium/iron disulfide primary cell of Comparative Example 6 was fabricated similarly to Example 66 to Example 70, except that the transition metal cation was not added.

### Example 71 to Example 75

LiClO₄ was used in place of lithium iodide (LiI). Propylene carbonate (PC) was used in place of 1,3-dioxolane (DOL). The transition metal cations listed in Table 2 were added in a form of triflate salt, to as much as the amounts of addition listed in Table 2. Except for these points, the lithium/iron disulfide primary cells of Example 71 to Example 75 were fabricated similarly in Example 1.

### Comparative Example 7

A lithium/iron disulfide primary cell of Comparative Example 7 was fabricated similarly to Example 71 to Example 75, except that the transition metal cation was not added.

### Example 76 to Example 80

LiPF₆ was used in place of lithium iodide (LiI). Ethylene carbonate (EC) was used in place of 1,3-dioxolane (DOL). The transition metal cations listed in Table 2 were added in a form of triflate salt, to as much as the amounts of addition listed in Table 2. Except for these points, the lithium/iron disulfide primary cells of Example 76 to Example 80 were fabricated similarly to Example 1.

### Comparative Example 8

A lithium/iron disulfide primary cell of Comparative Example 8 was fabricated similarly to Example 76 to Example 80, except that the transition metal cation was not added.

Evaluation

Thus-fabricated lithium/iron disulfide primary cells of Example 46 to Example 80, and of Comparative Example 2 to Comparative Example 8 were allowed to discharge by preliminary discharge to as much as 10% or around of the cell capacity, kept at room temperature (20° C.) for 1,000 hours, and the open-circuit voltage of thus-stored cells was measured. Results are shown in Table 2.

Table 2 shows that, by adding the transition metal cations, elevation of the open-circuit voltage could be largely suppressed similarly to the DOL-Lil system, also in any cases using LiCF₃SO₃, LiClO₄, LiPF₆ and Li(CF₃SO₂)₂N, or in any combinations with other solvents.

The present embodiments are by no means limited to the above-described examples, and can be modified and applied in various ways without departing from the spirit of the present disclosure.

For example, addition of the metal ion discussed in the above was in a form of triflate salt, whereas the anion species to be paired with the metal ion is not limited thereto.

Examples in the above adopted lithium/iron disulfide primary cells, whereas the present invention is also applicable to cases where copper (II) oxide, iron sulfide, iron complex oxide, bismuth trioxide or the like is used as the positive active material, and lithium and other alkali metals such as sodium, or metal compounds thereof is used as the negative electrode. The present embodiments are applicable not only to those of cylindrical type, but also to those of any other cell geometries including button-type, coin-type, square-type and so forth.

The present embodiments can suppress lowering in the discharge characteristics, and can suppress elevation of the open-circuit voltage during storage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A lithium/iron disulfide primary cell comprising:
a positive electrode using iron disulfide as a positive active material;
a negative electrode using lithium as a negative active material; and
an organic electrolytic solution including a transition metal cation.

2. The lithium/iron disulfide primary cell of claim 1, wherein the transition metal cation is any one ion selected from the group consisting of a Cu ion, a Sn ion, a Zn ion, a Ni ion and an Ag ion.

3. The lithium/iron disulfide primary cell of claim 1, wherein the transition metal cation included in the organic electrolytic solution in concentrations of 0.01 mol/kg to 1.0 mol/kg.

4. The lithium/iron disulfide primary cell of claim 1, wherein the organic electrolytic solution contains the transition metal cation in a form of salt expressed by Meⁿ⁺(CF₃SO₃)ₙ, where Meⁿ⁺ represents a transition metal cation, and n represents a valence number of the transition metal cation.

5. The lithium/iron disulfide primary cell of claim 1, wherein one or more solvents selected from the group consisting of propylene carbonate, ethylene carbonate, 1,2-dimethoxy ethane and 1,3-dioxolane are used independently or in a form of a mixed solvent, as the organic solvent.

6. The lithium/iron disulfide primary cell of claim 1, wherein an electrolyte in the organic electrolytic solution is any one selected from the group consisting of LiClO₄, LiPF₆, LiCF₃SO₃, Li(CF₃SO₂)₂N and LiI.
